(19) United States
(12) Patent Application Publication
(10) Pub. No.: US 2005/0007517 A1
(43) Pub. Date: Jan. 13, 2005

(54) Organic light emitting diode backlight integrated LCD

(75) Inventor: Munisamy Anandan, Del Valle, TX (US)

Correspondence Address: Dr. M. Anandan, 13009 Thome Valley Dr., Del Valle, TX, 78617, US

(73) Assignee: Organic Lighting Technologies LLC, Austin, TX (US)

(21) Appl. No.: 10/832,608

(22) Filed: Apr. 27, 2004

Related U.S. Application Data
(60) Provisional application No. 60/485,571, filed on Jul. 8, 2003.

(51) Int. Cl. G02F 1/1335

(52) U.S. Cl. 349/69

(57) ABSTRACT

An organic light emitting diode (OLED) backlight integrated LCD comprising three substrates of which one substrate is shared by LCD and OLED backlight. The shared substrate has two surfaces of which one surface contains, among other layers, a transparent electrode, an internal polarizer and an aligning layer for liquid crystal and faces the top substrate of LCD that also contains identical layers. A thin liquid crystal film is sandwiched between the two substrates containing the said layers. The second surface of said shared substrate contains active organic layers that include an anode and a cathode and faces the bottom substrate of OLED backlight. The two surfaces of the shared substrate are hermetically sealed to the other two substrates of LCD and OLED. When electrically activated the OLED backlight device substantially couples and transmit its generated light in to the LCD.

### CROSS REFERENCE TO RELATED APPLICATION

Benefit of Provisional patent Application No. 60/485,571 filed Jul. 8, 2003, Docket No. OLIT1140

Provisional Patent Application No. 60/461,098 filed Apr. 8, 2003; also filed as full patent on Mar. 31, 2004

U.S. Pat. No. 6,208,391—Fukushima, et al. Mar. 27, 2001

U.S. Pat. No. 5,754,159—Wood et. al, May 19, 1998

U.S. Pat. No. 6,542,145—Reisinger et. al, Apr. 1, 2003

U.S. Pat. No. 6,639,349—Bahadur, Oct. 28, 2003

### OTHER PUBLICATIONS

Y. Bobrov, L. Fennell, P. Lazarev, M. Paukshto, S. Remizov “Manufacturing of a Thin-Film LCD” Journal of the SID, 10/4, 317-321, 2002.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Transmissive Liquid Crystal Displays (LCDs) employed in display systems for various applications require a backlight device. Backlights are based on different technologies like, fluorescent lamp (FL) technology, electro-luminescent (EL) technology, Light emitting diode (LED) technology and organic light emitting diode (OLED) technology. As the backlight device is placed behind the planar LCD in intimate contact, it is preferable to have a flat geometry for the backlight device. Except LED technology all other technologies offer this benefit. In addition, the light coupling from the backlight to the LCD needs to be high to reduce light losses and hence increase in efficiency. It has also been observed that the variation in gap between the backlight and LCD causes optical defects like, appearance of fringes and rings. This invention relates to the integration of OLED backlight to LCD to increase the light coupling efficiency and reduction of optical defects together with the compactness of LCD-OLED assembly. This invention particularly lays emphasis on the use of internal polarizers to the LCD, which enables, the integration of OLED backlight device more robust and reliable against internal and external moisture and oxygen permeation.

Prior arts dealt with the integration of backlight devices to LCD using different technologies that included OLED backlight device as well. In one prior art of 1998, (U.S. Pat. No. 5,754,159) Wood et. al described the integration of a fluorescent backlight to LCD through a diffuser attached to the back substrate of LCD. The bottom surface of the diffuser, not facing the LCD, was used as one of the cover plate for the fluorescent light source. The other substrate with fluorescent cavity was sealed to the diffuser plate. For fluorescent light source to function in this manner, the diffuser plate ought to be of glass. There were two electrodes for the functioning of the fluorescent light source. One electrode was laid on the diffuser plate and the other electrode was laid on the substrate carrying the fluorescent cavity. The phosphor was coated on the electrode laid on the fluorescent cavity. An inert gas with mercury was filled in the fluorescent cavity. An application of sufficient voltage to the electrodes result in gas discharge that produces UV that falls on the phosphor to generate visible light. This invention is not strictly an integration of light source to LCD because the back surface of the back substrate of LCD was not utilized for sharing the function of one of the substrates of the backlight device. Further, the phosphor coated on one of the electrodes will erode away due to sputtering during operation and render the device useless.

In another invention by Bahadur et. al, (U.S. Pat. No. 6,639,349), OLED backlight device was appended to the external surface of a fluorescent backlight device by using the external surface of the fluorescent backlight device as one of the substrates of OLED backlight device. The purpose of the integration of OLED to the fluorescent backlight device was to operate OLED backlight device during night and turn off fluorescent backlight device. The operation was for ‘dual mode’ viewing to take advantage of bright fluorescent light during day and low intensity light from OLED during night. This invention did not integrate OLED backlight device directly to the LCD. Another art of 2001 described the integration of EL backlight device to LCD. Fukushima et. al (U.S. Pat. No. 6,208,391) described the integration of EL lamp making use of the external surface of the bottom polarizer of LCD. The external surface of the bottom polarizer had a transparent electrode of EL lamp and the other electrode was laid on the bottom substrate of EL lamp. Phosphor was sandwiched between the two electrodes. This invention did not integrate OLED backlight to LCD.

A very recent art by Reisinger et. al (U.S. Pat. No. 6,542,145) in 2003, describes the integration of OLED backlight to LCD. In this description, the external surface of the bottom polarizer of LCD is utilized for forming one electrode of OLED upon which organic layers are formed. The third substrate contains the second electrode of OLED. One drawback of this invention is the use of Indium Tin Oxide layer for both the electrodes of OLED. It is well known in the art of OLED technology that one of the electrodes needs to be cathode with material of low work function and the other electrode needs to be anode with material of high work function. In this invention both the electrodes are of the same material having the same work function. Hence the OLED device, according to this invention will either be inoperative or inefficient. Another drawback of this invention is the use of bottom surface of bottom polarizer of LCD, which is external to the bottom substrate. The polarizer is forming part of OLED substrate. Typically the polarizer sheets are laminated to the glass substrate of LCD. Because these sheets are plastics based, they contain lot of moisture. The moisture will de-sorb during the operation of OLED and migrate to OLED to degrade the life of OLED. It is well known that moisture creates ‘black spots’ in OLED and these spots expand both during operation and storage of OLED, thus rendering the device useless.

Still another invention by Anandan et. al (U.S. Patent under examination—Ser. No. 60461098 with filing date Apr. 08, 2003) describes the integration of three flat panel devices. Each flat panel device in this disclosure shares the substrate of each device, starting from LCD going through a guest-host cell and finally to the backlight device. Unlike all the inventions of prior art, this invention integrates three flat panel devices through sharing of substrates.

### BRIEF SUMMARY OF THE INVENTION

According to the present invention, LCD is integrated to OLED backlight device through series of process steps. Most LCDs used in majority of applications like, note book computers, palm pilot, digital clock, digital camera, both direct view and projection television, auto dash board, color cell phone and the like, incorporate two polarizer films. These LCDs invariably come under the family of ‘twisted nematic’ or ‘super twisted nematic’ or ‘ferro-electric LCD. Polarizer films are not incorporated in certain other families that include polymer dispersed liquid crystal display’ (PDLCD) and ‘dichroic liquid crystal display’ (DLCD). For LCDs employing polarizer films, according to this invention, LCD comprises a top glass plate, the inside surface of which has a transparent Indium Tin Oxide (ITO) coating. The layer following this is a planarization layer followed by ‘thin crystal film’ (TCF) layer made by Optiva Incorporated. Following this layer is a polyimide alignment layer, followed by the main liquid crystal film, followed by a polyimide alignment layer, followed by TCF film followed by a planarization layer and finally followed by another ITO on the inner surface of the bottom glass substrate. The completed LCD, with its perimeter seal, is sputtered with ITO on the external surface of the bottom glass substrate of LCD, through a suitable mask, to serve as anode, with high work function, of the subsequent OLED stack. Alternatively, this ITO layer can be pre-formed prior to the fabrication of LCD. After sputtering the ITO layer, other organic layers like, the hole-injection layer, hole transport layer, light generation layer and electron transport layer and a cathode layer of low work function are deposited. Finally a glass cover, with suitable dessicant, is used for perimeter sealing of the OLED stack, at the border of the external surface of the bottom glass substrate of LCD. It is important that the perimeter seal of LCD be vacuum tight to undergo all OLED processes in vacuum of the order of 10⁻⁷ torr. Thus the integrated structure consists of three glass substrates instead of the conventional four substrates. The same integrated structure holds, even if LCD is made of flexible substrate and OLED is made of flexible substrate, except that additional moisture barrier multi-layers have to be laid on flexible substrates both for LCD and OLED, prior to the active layers.

As the Optiva's TCF polarizer layer is internal to the LCD, the integrated structure is more durable because the external surface of LCD is glass instead of plastic lamination. Additionally, the life of OLED is enhanced because the glass surface de-sorbs less moisture compared to plastic. Due to the elimination of one substrate and inclusion of internal polarizer, the integrated structure is 50% thinner than the conventional structure and reduces the manufacturing costs. In the integrated structure, the light coupling, from backlight device to LCD, is maximum. For LCDs that do not incorporate polarizers, LCD fabrication is simpler in that planarization layers and TCF layers can be eliminated. In an alternate sequence of fabrication, for LCDs that do not employ active matrix substrates, OLED backlight device can be fabricated first and the LCD fabrication can be done next on the external surface of the light emitting side of glass substrate of OLED. It is preferable to start the fabrication of low yielding device first and the high yielding device next for LCDs that do not employ active matrix substrates. This is necessary to have the compatibility in process temperature of both the devices.

It is an object of the invention to provide an integrated OLED backlight device to the LCD to increase the light coupling to LCD and thus reduce the light losses.

It is another object of this invention to employ internal polarizers to LCD, and thus eliminate plastic lamination of traditional polarizers, to enhance the life performance of the integrated OLED backlight device.

It is yet another object of this invention to provide low weight and thinner integrated device by using three substrates instead of four substrates.

### BRIEF DESCRIPTION OF THE DRAWINGS

FIG. 1 is an isometric view of an OLED backlight device.

FIG. 1B is a cross sectional view of OLED backlight device taken from FIG. 1

FIG. 2 is an isometric view of a traditional LCD.

FIG. 2B is a cross sectional view of the traditional LCD taken from FIG. 2.

FIG. 3 is an isometric view of conventional assembly of LCD and OLED backlight device.

FIG. 4 is the plan view of the external surface of the bottom glass substrate of LCD illustrating the transparent anode pattern of OLED.

FIG. 5 is the plan view of the external surface of the bottom substrate of LCD, illustrating the anode pattern and stack of multi-layer thin films of OLED.

FIG. 6 is an isometric view of OLED backlight device integrated to LCD.

FIG. 7 is the cross section of the LCD-OLED backlight integrated.

FIG. 8 is the cross section of LCD alone that is shown as integrated to OLED backlight device in FIG. 6.

### DETAILED DESCRIPTION

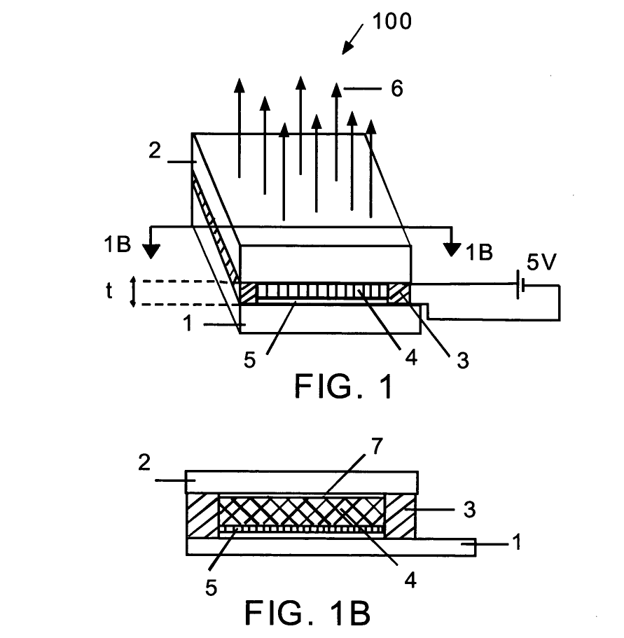

FIG. 1 shows the isometric view of an OLED backlight device 100. An organic multi-layer stack 4 is enclosed between top glass substrate 2 and bottom glass substrate 1, more precisely cover glass. The thickness of the organic layer is denoted by t and is around 125 nm to 200 nm. The stack 4 is sealed all around by a perimeter seal 3, which is hermetic to prevent moisture and Oxygen entering the device. When a voltage of 5V is applied across the stack 4, through the reflective cathode 5 and the transparent anode, not shown in FIG. 1, the organic stack emits visible light 6. Also not shown in FIG. 1 is a gap between cathode 5 and bottom substrate 1. FIG. 1B is the cross section taken from FIG. 1. The OLED stack, enclosed between the top glass substrate 2 and bottom substrate 1 and sealed at the perimeter by the seal 3, contains a cathode 5 and an anode 7 that inject electrons and holes respectively to the organic stack 4. The anode 7 is usually of Indium Tin Oxide (ITO). It can be noticed that there is a gap between cathode 5 and glass cover 1. The cathode is of low work function material and is usually from one of the materials of Lithium, Cesium, Barium, Strontium, Calcium, Aluminum, Magnesium or combination of these materials or combination of oxides or fluorides of these materials. Widely known cathode materials are Mg:Ag; Li:Al; LiF:Al; CsF:Al; BaO; Ca. In addition to the requirement of low work function, the cathode material should form efficient electron injection interface with the adjacent electron transport layer.

There are two well-known structures in OLED namely, ‘up-emitting’ and ‘down-emitting’. In an ‘up-emitting’ structure, the generated light comes out through the cathode and in a ‘down-emitting’ structure, the generated light comes through the anode. Most ‘down-emitting’ structures employ transparent ITO, to a thickness of 40 nm, to transmit light with a transmission of greater than 90%. In up-emitting structure, the cathode material has to be transparent like ITO. All the known cathode materials do not have optical transmission as good as ITO. Hence the cathode layer thickness is greatly reduced during the process to make it transparent. Too thin a layer results in low electrical conductivity. Hence an optimum thickness in the range of 7 nm to 12 nm is conventionally employed for best results.

The organic layers consist of, starting from the cathode side, electron transport layer, light generation layer, hole transport layer and hole injection layer. Sometimes electron transport layer and light generation, usually doped with another organic material to increase the light generation efficiency, will be of the same organic material. Similarly, hole injection layer and hole transport layer will be of the same material. The thickness of individual layer varies between 15 nm to 75 nm.

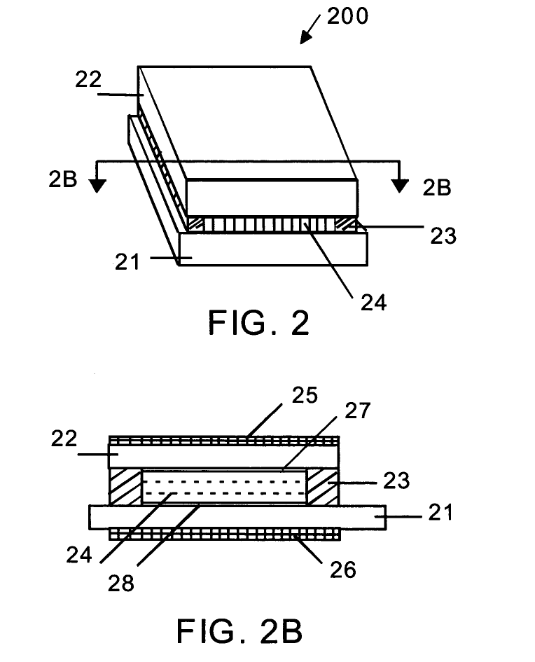

FIG. 2 is an isometric view of a traditional twisted nematic LCD, 200. A thin, around 5 micron, liquid crystal film 24 is sandwiched between top glass substrate 22 and bottom glass substrate 21 and sealed all around by a perimeter seal 23 to serve as a hermetic seal for the display. FIG. 2B is a cross sectional view of LCD 200 taken from FIG. 2. Thin liquid crystal film 24 is sandwiched between the top glass substrate 22 and bottom glass substrate 21 and sealed at the perimeter by the seal 23. The external surface of the top glass substrate 22, is plastic laminated with a polarizer 25 and similarly the external surface of the bottom glass substrate 21 is plastic laminated with a polarizer 26. The polarizers 25 and 26 are arranged optically parallel for the display functioning of LCD. There are certain applications wherein the polarizers are arranged optically crossed. The transparent electrode 27, on the inner surface of the top glass substrate 22, and the transparent electrode 28, on the inner surface of the bottom substrate 21, serve for applying voltage across the liquid crystal film 24.

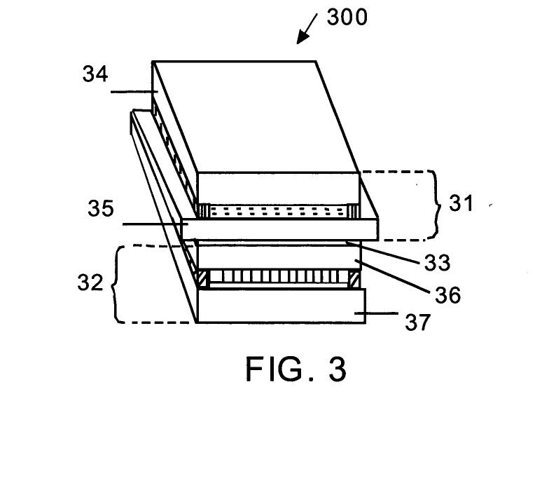

FIG. 3 shows the isometric view of the conventional assembly 300 of the backlight device with the LCD. LCD 31 is assembled over the OLED backlight device 32 and a protective film 33 is placed between LCD 31 and OLED backlight 32. It is worth noting that the assembly has four substrates 34, 35, 36 and 37 with a protective layer 33 in between. Light losses take place at the protective layer 33 and in the substrate 36.

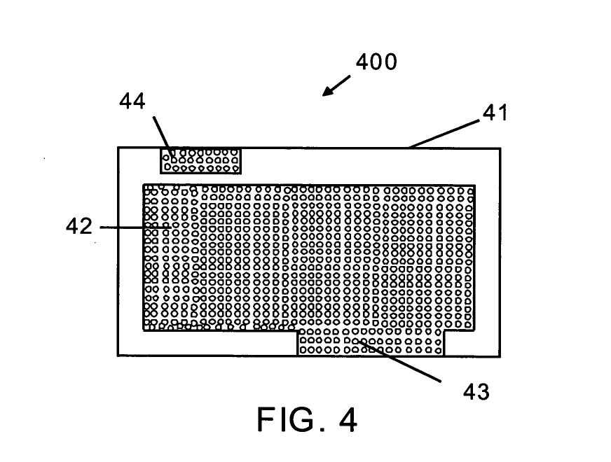

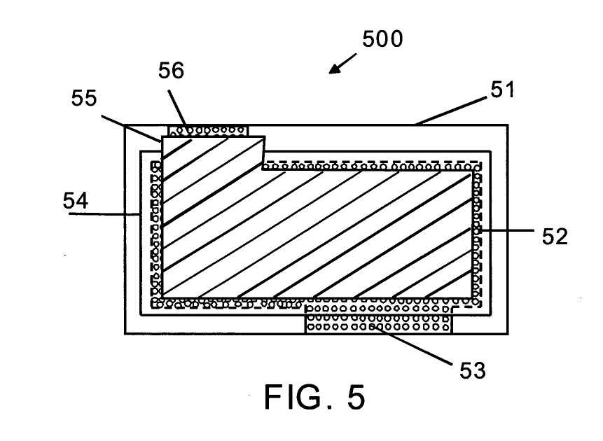

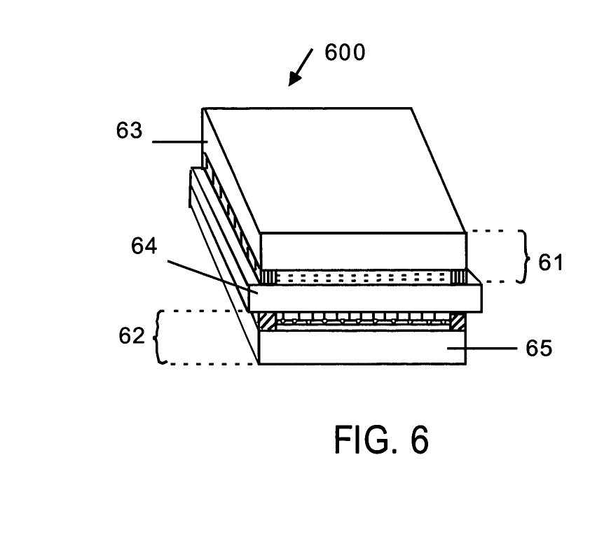

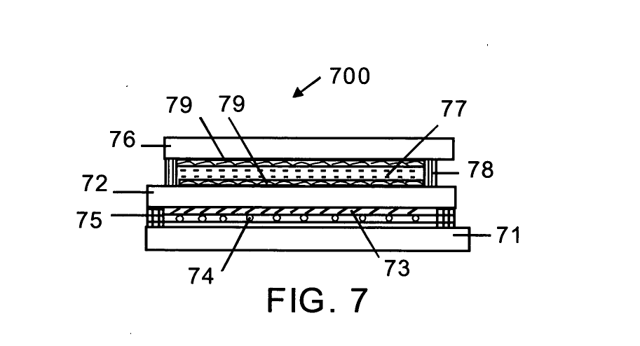

FIG. 4 is a plan view 400 of the external surface of bottom glass plate 41 of completed LCD, according to this invention. This surface faces the OLED backlight device. The completed LCD, with the external surface of substrate 41, is placed in a vacuum chamber, that is back-filled with inert gas, and is sputtered with ITO 42 to a thickness of 40 nm, through a shadow mask, to obtain a cathode lead-out 44 and anode lead-out 43. Subsequently the glass plate 41 and the surface of ITO becomes the substrate for OLED. LCD, whose external surface of glass substrate 41, processed in this manner, faces sequence of OLED processes without coming out of the vacuum chamber and finally undergoes a hermetic sealing process inside Nitrogen controlled glove-box by directly being transported from vacuum chamber to the glove box. FIG. 5 is a plan view 500 of the external surface of bottom glass plate 51 of LCD, with full LCD in tact, that has undergone all the OLED processes, including multi-layer organic layer deposition. Multi-layer organic layer 54 is over ITO 52 and reflective cathode layer 55 is over multi-layer organic layer 54. Portion of cathode lead-out 56 and portion of anode lead-out 53 are clear of organic layers with the help of appropriate shadow masks. A cover glass, not shown in FIG. 5, is sealed over the glass plate 51 at the periphery. This could be clearly seen in FIG. 6 and FIG. 7.

FIG. 6 is an isometric view of the assembly of the LCD-OLED backlight integrated structure 600 according to the present invention. The uniqueness of the present invention lies in the use of internal polarizer, not shown in FIG. 6 but shown in FIG. 7, for LCD that is integrated to the OLED backlight device. The integrated structure shown in FIG. 6 illustrates the LCD 61, with its top substrate 63, sharing its bottom substrate 64 with OLED backlight device 62, whose top substrate is 64. For OLED backlight device 62, the glass plate 65 is just a cover glass plate used for hermetic sealing with the shared substrate 64 at the periphery. Plate 65 does not contain any active elements of OLED except a dessicant, not shown in FIG. 6. It is significant to note that there is no protective sheet between OLED and LCD and the light coupling to LCD from OLED is maximum. To have this maximum light coupling condition, It is important that a fraction of light that is likely to be wave-guided laterally through the thickness of substrate 64 is minimized by a careful well known standard techniques.

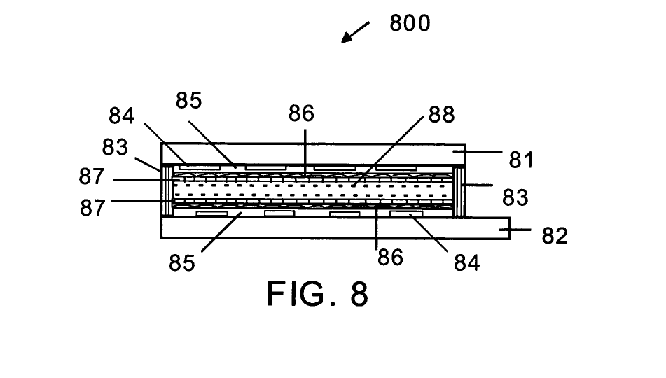

FIG. 7 is the cross sectional view of the integrated LCD-OLED assembly 700. The LCD comprises a top glass substrate 76 followed by a stack of layers 79 consisting of transparent electrode pattern, a planarization layer, internal polarizer, such as TCF material from Optiva, and a plyimide alignment layer. This stack is best shown in FIG. 8. Following the stack 79 is a thin liquid crystal film 77, which is followed by another stack of 79. The shared substrate 72 has active elements of LCD on the surface opposite to OLED and active elements of OLED on the surface opposite to LCD. Organic stack 73, which includes transparent anode, and reflective cathode 74, of OLED, are on the shared substrate 72. Bottom Glass substrate 71 of OLED merely serves as a cover glass for hermetic sealing. It can be noted that there is a gap between the cathode 74 and cover glass 71. The shared substrate 72 is sealed at its periphery, on both surfaces, to LCD via the seal 78 and to OLED via the seal 75. It should be recognized that liquid crystal is filled after the perimeter sealing to the top LCD substrate 76. The exclusion of plastic laminated conventional polarizer inside OLED enhances the life performance of this LCD-OLED integrated assembly.

FIG. 8 is the cross section of LCD 800 that is integrated, according to this invention, in FIG. 7. The shared substrate 82, OLED side is not shown in FIG. 8, is sealed to the top glass substrate 81 of LCD through the seal 83, which is usually an epoxy seal. Transparent electrodes 84, usually ITO, on both the substrates are followed by a planarization layer 85, such as SiO₂, which, in turn, is followed by an internal polarizer 86, such as TCF layer of Optiva Incorporated. Following the internal polarizer 86 is a liquid crystal molecule aligning plyimide layer 87 contacting which is the thin liquid crystal film 88.

The embodiment shown in FIG. 6 can be readily manufactured. The key to the robust and reliable integrated structure of the present invention is the use of ‘internal polarizers’ for LCDs using polarizers. For LCDs that do not employ active matrix substrates, the process temperatures of LCD and OLED are compatible. Under this condition two sequences of manufacturing of this integrated assembly are possible. The first sequence lays emphasis on the low yielding device to be fabricated first. The high yielding device is fabricated next integral to the low yielding device. For example, if the OLED has lower yield than LCD, because of matured manufacturing nature of LCD, OLED is fabricated first. Using the external surface of the light emitting side of OLED, the processes for LCD should commence next. As the OLED is a solid state device and is filled with Nitrogen at atmospheric pressure, the shared substrate that is subjected to LCD's low temperature process conditions will be stable through all the process steps of LCD. For LCDs employing active matrix substrates, LCD is fabricated first and then OLED process should commence on the external surface of the bottom substrate, shared substrate, of LCD. Since OLED processes are done in vacuum, it is important that the sealing of LCD is vacuum tight to keep the liquid crystal film stable.

It will be apparent to those skilled in the art that various modifications and variations can be made in the construction, configuration and/or operation of the present invention without departing from the scope or spirit of the invention. For example, OLED backlight device in the foregoing illustration is for the fabrication of a single diode. In fact, any number of diodes, one top of each other, can be integrally processed on the shared substrate to have a series operation or parallel operation of OLEDs. In the same manner, different colors of OLEDs can be integrally processed on the shared substrate. In the foregoing illustration, ‘down-emitting’ structure of OLED and its processing sequence are described. In this respect one example of variation is to change to ‘up-emitting’ structure. In this case, the shared substrate merely serves a cover lid for OLED and the bottom substrate of OLED becomes the active substrate that starts with a reflective anode layer, followed by organic stack and finally a thin transparent cathode layer. Another example of the variation is the use of flexible substrates both for LCD and OLED instead of glass substrates. Variation in sealing of OLED through encapsulation of the OLED stack followed by perimeter metal seal or epoxy seal can also be done. Variation in the profile of the shared substrate for minimizing the light loss due to wave guiding can also be done. Finally, this integrated OLED backlight to LCD can be done for any type and family of LCD. Thus it is intended that the present invention covers the modifications and variations of the invention provided they come within the scope of the appended claims and their equivalents.

1. An organic light emitting diode backlight integrated LCD comprising:
a liquid crystal display having two substrates containing two surfaces each, the inner surface of top substrate incorporating transparent electrode followed by, among other layers, an internal polarizer and a liquid crystal aligning layer, the inner surface of a bottom substrate, opposing the top substrate incorporating transparent electrode followed by, among other layers, an internal polarizer and a liquid crystal aligning layer, a liquid crystal film being sandwiched between the liquid crystal aligning layers of the inner surface of the said top substrate and the inner surface of the said bottom substrate;
an organic light emitting diode backlight containing two substrates, of which one substrate, specifically the bottom substrate of the said liquid crystal display, is shared to have the external surface, facing away from liquid crystal film, to contain a transparent anode, followed by several organic layers and finally a reflective cathode completing the OLED stack and the second substrate, containing a dessicant, serving as lid for the said OLED stack;
said shared substrate having two surfaces, the surface facing the said liquid crystal film being placed in contact with the said top substrate of said liquid crystal display in substantial alignment and sealed hermetically, at the perimeter, in a Nitrogen controlled environment and the second surface facing the OLED stack being placed in contact with the said lid of the said OLED backlight in substantial alignment and sealed hermetically, at the perimeter, in a Nitrogen controlled environment;
said OLED backlight and said LCD forming an integrated assembly, containing three substrates of which one substrate is shared between the said OLED and said LCD and when the said OLED backlight is electrically activated, said OLED backlight generates light and transmits light substantially in to the said LCD.

2. An organic light emitting diode backlight integrated LCD as recited in claim 1 wherein the substrates of the integrated assembly are rigid glass or flexible plastic.

3. An organic light emitting diode backlight integrated LCD as recited in claim 1 wherein the substrates of the integrated assembly are combination of glass and plastic.

4. An organic light emitting diode backlight integrated LCD as recited in claim 2 and 3 wherein the OLED backlight is fabricated of small molecule OLED technology or polymer OLED technology.

5. An organic light emitting diode backlight integrated LCD as recited in claim 4 wherein LCD technology employs external polarizers or without polarizers.

6. An organic light emitting diode backlight integrated LCD as recited in claim 4 wherein the OLED backlight device emits light in the form of continuous sheet in different colors or in the form of series of stripes in different colors.

7. An organic light emitting diode backlight integrated LCD as recited in claim 1 wherein the seal, at the perimeter of said shared substrate to the opposing substrate of said OLED stack, is of metal or epoxy and the said OLED stack is encapsulated by a thin film hermetic seal.

8. An organic light emitting diode backlight integrated LCD as recited in claim 1 wherein the cathode material is Lithium or Cesium or Barium or Strontium or Calcium or Aluminum or Magnesium or combination of these materials or combination of oxides or fluorides of these materials or Mg:Ag or Li:Al or LiF:Al or CsF:Al or BaO or Mg:Ag:CsF or Mg:Ag:LiF.

9. An organic light emitting diode backlight integrated LCD comprising:
a liquid crystal display having two substrates containing two surfaces each, the inner surface of top substrate incorporating transparent electrode followed by, among other layers, an internal polarizer and a liquid crystal aligning layer, the inner surface of a bottom substrate, opposing the top substrate incorporating transparent electrode followed by, among other layers, an internal polarizer and a liquid crystal aligning layer, a liquid crystal film being sandwiched between the liquid crystal aligning layers of the inner surface of the said top substrate and the inner surface of the said bottom substrate;
an organic light emitting diode backlight containing two substrates, of which one substrate, specifically the bottom substrate of the said liquid crystal display, is shared to have the external surface, facing away from liquid crystal film, to contain a transparent anode, followed by several organic layers and a reflective cathode completing the OLED stack and repetition of several OLED stack one over the other to form of series connected OLEDs and the second substrate, containing a dessicant, serving as lid for the said OLED stacks;
said shared substrate having two surfaces, the surface facing the said liquid crystal film being placed in contact with the said top substrate of said liquid crystal display in substantial alignment and sealed hermetically, at the perimeter, in a Nitrogen controlled environment and the second surface facing the OLED stacks being placed in contact with the said lid of the said OLED backlight in substantial alignment and sealed hermetically, at the perimeter, in a Nitrogen controlled environment;
said OLED backlight and said LCD forming an integrated assembly, containing three substrates of which one substrate is shared between the said OLED and said LCD and when the said OLED backlight is electrically activated, said OLED backlight generates light in every OLED stack connected in series and transmits light substantially in to the said LCD.

10. An organic light emitting diode backlight integrated LCD as recited in claim 9 wherein the said OLED stacks of said OLED backlight is processed to configure in several coplanar stacks, connecting all the coplanar stacks in series.

11. An organic light emitting diode backlight integrated LCD as recited in claim 10 wherein the stacks emit different colors of light.

12. An organic light emitting diode backlight integrated LCD as recited in claim 9 wherein the said OLED stacks emit different colors of light in the form of sheet or in the form of series of stripes.

13. An organic light emitting diode backlight integrated LCD comprising:
a liquid crystal display having two substrates containing two surfaces each, the inner surface of top substrate incorporating transparent electrode followed by, among other layers, an internal polarizer and a liquid crystal aligning layer, the inner surface of a bottom substrate, opposing the top substrate incorporating transparent electrode followed by, among other layers, an internal polarizer and a liquid crystal aligning layer, a liquid crystal film being sandwiched between the liquid crystal aligning layers of the inner surface of the said top substrate and the inner surface of the said bottom substrate;
an organic light emitting diode backlight containing two substrates, of which one substrate, specifically the bottom substrate of the said liquid crystal display, is shared to have the external surface, facing away from liquid crystal film, to function as a lid, with dessicant, for the OLED stack that starts from a reflective anode on the bottom substrate of the said OLED backlight followed by several organic layers and finally a thin transparent cathode, on the final organic layer, that faces the said shared substrate;
said shared substrate having two surfaces, the surface facing the said liquid crystal film being placed in contact with the said top substrate of said liquid crystal display in substantial alignment and sealed hermetically, at the perimeter, in a Nitrogen controlled environment and the second surface facing the OLED stack being placed in contact with the said OLED substrate, containing the active OLED stack, in substantial alignment and sealed hermetically, at the perimeter, in a Nitrogen controlled environment;
said OLED backlight and said LCD forming an integrated assembly, containing three substrates of which one substrate is shared between the said OLED and said LCD and when the said OLED backlight is electrically activated, said OLED backlight generates light and transmits light substantially in to the said LCD.

14. An organic light emitting diode backlight integrated LCD as recited in claim 13 wherein the said OLED stack has several stacks one over the other to form a series connected OLED stack.

15. An organic light emitting diode backlight integrated LCD as recited in claim 14 wherein the OLED stacks are processed to emit different colors of light in the form of sheet or in the form of series of stripes.

16. An organic light emitting diode backlight integrated LCD as recited in claim 1 through 15 that is employed in display system for displaying information in the form of data or video images.
